(19) United States
(12) Patent Application Publication
(10) Pub. No.: US 2004/0156149 A1
(43) Pub. Date: Aug. 12, 2004

(54) Method of and apparatus for plastic optical-chip encapsulation

(76) Inventors: Odd Steijer, Bromma (SE); Ivar Hamberg, Stockholm (SE); Paul Eriksen, Tyreso (SE); Ulf Holm, Sollentuna (SE); Jan-Ake Engstrand, Trangsund (SE); Hans-Christer Moll, Bandhaden (SE); Jan-Erik Falk, Kungsangen (SE); Torbjorn Palm, Jarfalla (SE); Annika Solehav, Stockholm (SE)

Correspondence Address: Jenkens & Gilchrist, P.C., Suite 3200, 1445 Ross Avenue, Dallas, TX, 75202-2799, US

(21) Appl. No.: 10/649,516

(22) Filed: Aug. 25, 2003

Related U.S. Application Data
(60) Provisional application No. 60/408,543, filed on Sep. 5, 2002.

(51) Int. Cl. H02H 3/00

(52) U.S. Cl. 361/1

(57) ABSTRACT

An opto-mechanical interface apparatus includes an optical hybrid, an electronic hybrid adapted to receive electronic components, an adapter fixture for fixing the electronic hybrid and the optical hybrid to one another to form a combined hybrid, a lower-capsule part, and an upper-capsule part adapted to mate with the lower-capsule part. Mating of the upper-capsule part and the lower-capsule part encloses at least part of the combined hybrid. The apparatus forms an opto-mechanical interface for making external optical connection(s).

### CROSS-REFERENCE TO RELATED APPLICATIONS

This patent application claims priority from and incorporates by reference the entire disclosure of U.S. Provisional Patent Application No. 60/408,543, which was filed on Sep. 5, 2002.

### BACKGROUND OF THE INVENTION

1. Technical Field of the Invention

The present invention relates in general to encapsulation of optical chips and, more particularly, to non-hermetically-sealed encapsulation of optical chips.

2. Description of Related Art

Optical modules include optical chips that are typically enclosed in hermetically-sealed metal capsules and are provided with fiber tails (i.e., pigtails) for optical connections. Selection of materials and processes of manufacturing for the optical modules often makes the optical modules expensive to produce. The pigtails also often make the metal capsules difficult to handle during manufacturing and testing, such as assembling of the optical modules onto printed circuit boards.

### SUMMARY OF THE INVENTION

These and other drawbacks are overcome by embodiments of the invention, which provides a method of and apparatus for optical-chip encapsulation. In an embodiment of the invention, an opto-mechanical interface apparatus includes an optical hybrid, an electronic hybrid adapted to receive electronic components, an adapter fixture for fixing the electronic hybrid and the optical hybrid to one another to form a combined hybrid, a lower-capsule part, and an upper-capsule part adapted to mate with the lower-capsule part. Mating of the upper-capsule part and the lower-capsule part encloses at least part of the combined hybrid.

In another embodiment of the invention, a method of assembling an opto-mechanical interface apparatus includes forming a combined hybrid, placing the combined hybrid in a first capsule part and mating a second capsule part with the first capsule part. The step of forming the combined hybrid includes attaching an adapter fixture to an electronic hybrid and attaching an optical hybrid to the electronic hybrid. Mating of the first capsule part and the second capsule part encloses at least part of the combined hybrid. The assembled apparatus includes an opto-mechanical interface for making external optical connection(s).

### BRIEF DESCRIPTION OF THE DRAWINGS

A more complete understanding of exemplary embodiments of the invention may be achieved by reference to the following Detailed Description of Exemplary Embodiments of the Invention when taken in conjunction with the accompanying Drawings, in which like features are illustrated by like numerals, wherein:

FIG. 1 is a perspective view of an exemplary plastic capsule in accordance with principles of the invention;

FIG. 2 is a perspective view of an optical hybrid for a transceiver in accordance with principles of the invention;

FIG. 3 is a perspective view of an electronic hybrid in accordance with principles of the invention;

FIG. 4 is a perspective view of the electronic hybrid with an adapter fixture attached in accordance with principles of the invention;

FIG. 5 is a perspective view of a lower-capsule part of the plastic capsule in accordance with principles of the invention;

FIG. 6 is a perspective view of an upper-capsule part of the plastic capsule in accordance with principles of the invention;

FIG. 7 is a perspective view of a combined hybrid in accordance with principles of the invention;

FIG. 8 is a perspective view of the plastic capsule, including the upper-capsule part and the lower-capsule part with the combined hybrid assembled thereon, in accordance with principles of the invention;

FIG. 9 is a side view of the plastic capsule that illustrates the upper-capsule part and the lower-capsule part in a mated configuration on either side of the optical hybrid and the electronic hybrid; and

FIG. 10 is a flow chart illustrating a plastic-capsule assembly process in accordance with principles of the invention.

### DETAILED DESCRIPTION OF EXEMPLARY EMBODIMENTS OF THE INVENTION

A more cost-effective alternative to hermetically-sealed metal capsules are non-hermetically-sealed plastic capsules. The plastic capsules permit high-volume manufacture and also enable replacement of fiber tails by an optical connector that is integrated into the plastic capsule.

FIG. 1 is a perspective view of an exemplary plastic capsule 100 in accordance with principles of the invention. The plastic capsule 100 includes a lower-capsule part 102 and an upper-capsule part 104. An MT-RJ receptacle 106 is shown as part of the plastic capsule 100. The MT-RJ receptacle 106 is an example of an opto-mechanical connection that may be used in various embodiments of the invention. Any small form factor fiber-optic connector may be used. The MT-RJ receptacle 106 is a type of small form factor fiber-optic connector. Small form factor (SFF) refers to any of several physically-compact connector designs that have been developed for use in fiber-optic systems. SFF connectors are typically about half the size of conventional connectors. SFF connectors include the LC by LUCENT, the VF-45 by 3M, and the MT-RJ by TYCO. The MT-RJ receptacle 106 is based on a so-called mini-MT ferrule and, in various embodiments of the invention, may house 1-4 optical fibers. A geometrical design and a pin configuration of the embodiment of the invention shown in FIG. 1 are preferably adapted to the SFF standard. The SFF standard defines exterior dimensions and electrical connections of optical connectors. The SFF standard also defines alternative acceptable opto-mechanical connections, such as, for example, double-LC.

The plastic capsule 100 includes five building blocks: 1) an optical hybrid (not shown in FIG. 1); 2) an electronic hybrid (not shown in FIG. 1); 3) an adapter fixture (not shown in FIG. 1); 4) the lower-capsule part 102; and 5) the upper-capsule part 104. The optical hybrid is an optical part that includes an optical chip and a fiber connector provided with a ferrule on a silicon carrier. The optical hybrid includes a testable unit with regard to the function of the optical chip and a degree of connection between the optical chip and optical fiber(s) of the optical connector. The optical hybrid may have a different design depending on whether the optical hybrid includes transmitter chips (e.g., lasers), receiver chips (e.g., PIN diodes) or both types. The optical hybrid may also have one or more separate carriers.

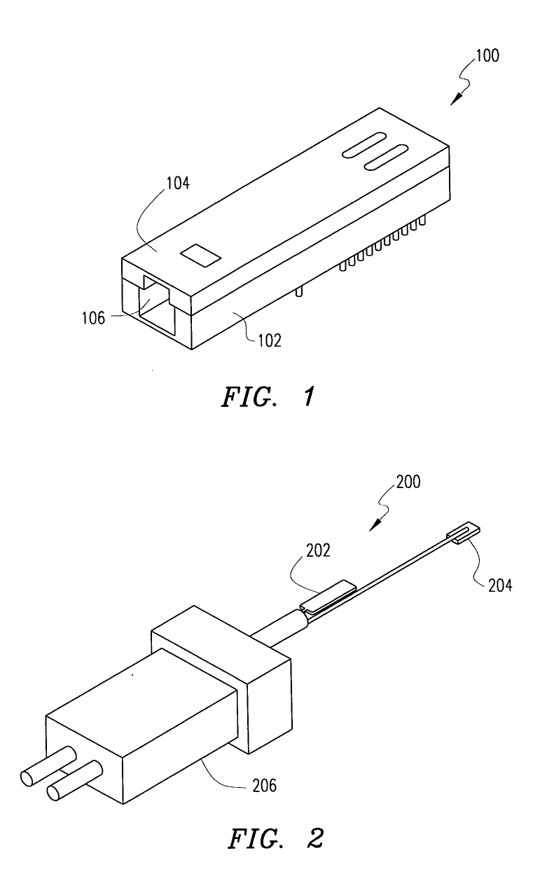

FIG. 2 is a perspective view of an optical hybrid 200 for a transceiver (i.e., a combined transmitter and receiver) in accordance with principles of the invention. The optical hybrid 200 has two separate carriers. A first carrier 202 has a transmitter chip and a second carrier 204 has a receiver chip. The optical hybrid 200 also has a ferrule 206. An optical fiber is connected to each of the transmitter chip and the receiver chip. The optical hybrid 200 may be a multi-channel optical hybrid, which can be designed to have several fibers connected to a single carrier.

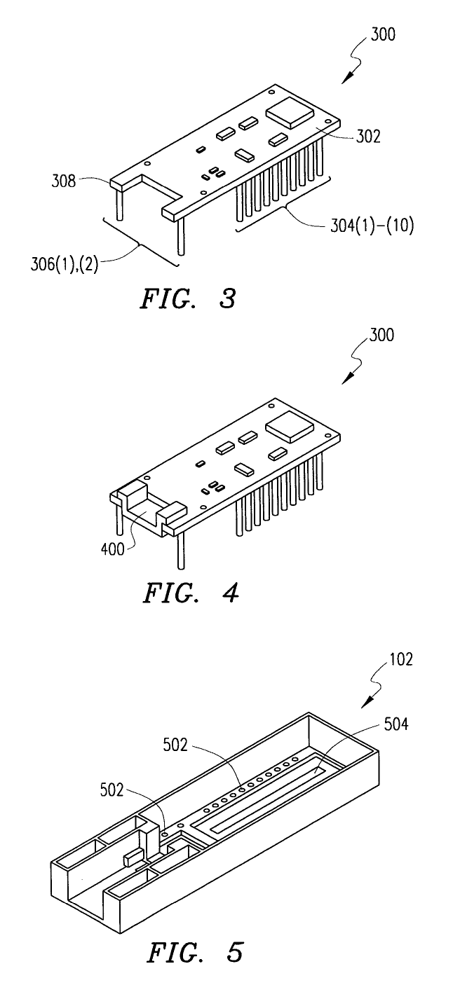

FIG. 3 is a perspective view of an electronic hybrid 300 of the plastic capsule 100 in accordance with principles of the invention. The electronic hybrid 300 includes a printed circuit board (PCB) 302, on which electronic components may be assembled. The electronic components may be mounted on each side of the PCB 302. The PCB 302 is also provided with pins 304 for making external electrical connections, pins 304(1)-304(10) having been shown in FIG. 3. Although the pins 304(1)-304(10) are shown in FIG. 3, any necessary number of pins 304 may be included as part of the electronic hybrid 300 as dictated by design considerations.

The PCB 302 is preferably provided with studs 306 in a front portion 308 of the PCB 302 as mandated by the SFF standard. Although studs 306(1) and 306(2) are shown in FIG. 3, any number of studs 306 may be included as part of the electronic hybrid 300 as dictated by design considerations. The studs 306 enable extra-stable fastening during assembly. The extra-stable fastening is particularly useful in order to prevent forces that occur during plugging in and unplugging of a plastic capsule from loading solder joints at the pins 304.

FIG. 4 is a perspective view of the electronic hybrid 300 with an adapter fixture 400 attached in accordance with principles of the invention. The adapter fixture 400 is used to position and fasten the optical hybrid 200 on the electronic hybrid 300.

FIG. 5 is a perspective view of the lower-capsule part 102. The lower-capsule part 102 constitutes a bottom part of the plastic capsule 100 and is adapted to provide an accurate positioning of a combined optical and electronic hybrid, and especially a ferrule thereof The lower-capsule part 102 typically has lead-throughs 502 for the pins 304 and the studs 306 of the electronic hybrid 300, as well as at least one airing hole 504 to avoid trapping moisture inside the plastic capsule 100. A portion of opto-mechanics in the plastic capsule 100 is typically located in the lower-capsule part 102, while another portion of the opto-mechanics is typically located in the upper-capsule 104 part. The opto-mechanics are typically designed in order to connect to a standard optical connector, such as, for example, an MT-RJ or LC connector.

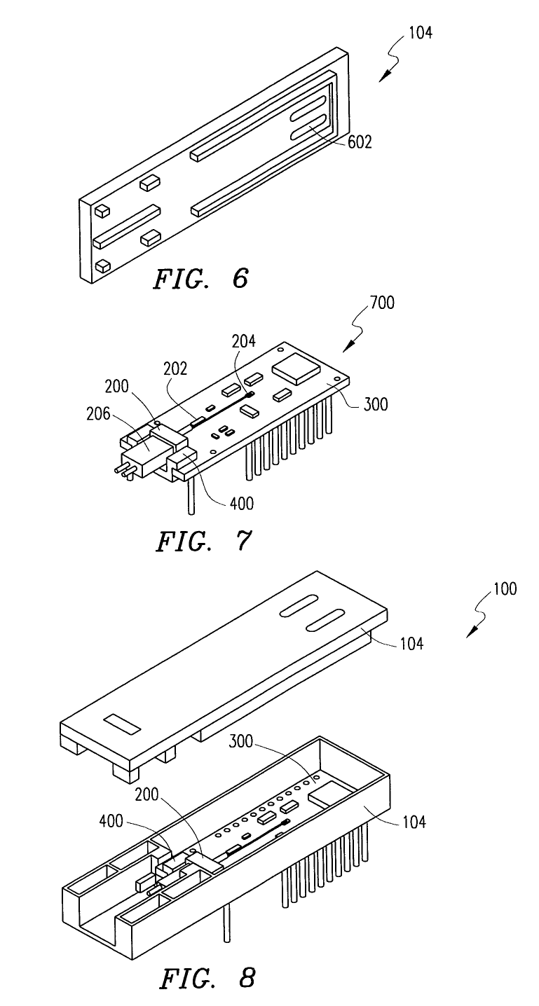

FIG. 6 is a perspective view of the upper-capsule part 104. The upper-capsule part 104 has several functions. The upper-capsule part 104 contains an upper part of an opto-mechanical interface and fixes contents of the plastic capsule (e.g., the optical hybrid and the electronic hybrid) when pressed against the lower-capsule part 102. Further, the upper-capsule part 104 provides a lid for mechanical protection of the contents of the plastic capsule 100. The upper-capsule part 104 and the lower-capsule part 102 of the plastic capsule 100 may be assembled by snap-locking, gluing, ultra-sound welding, or the like. The upper-capsule part 104 is typically provided with at least one airing hole 602.

FIG. 7 is a perspective view of a combined hybrid 700 in accordance with principles of the invention. The combined hybrid 700 results from fixation of the optical hybrid 200 to the electronic hybrid 300 via the adapter fixture 400. The adapter fixture 400 enables a simple fixation of the optical hybrid 200 to the electronic hybrid 300. The adapter fixture 400 is typically force fit to the electronic hybrid 200 and a ferrule is glued to the adapter fixture 400.

FIG. 8 is a partially-exploded perspective view of the plastic capsule 100, including the lower-capsule part 102 with the combined hybrid assembled therein and also the upper-capsule part 104, in accordance with principles of the invention. FIG. 8 illustrates how the lower-capsule part 102 may be mated with the upper-capsule part 104. The lower-capsule part 102 fixes the ferrule 206 in a proper position and forms an opto-mechanical interface together with the upper-capsule part 104.

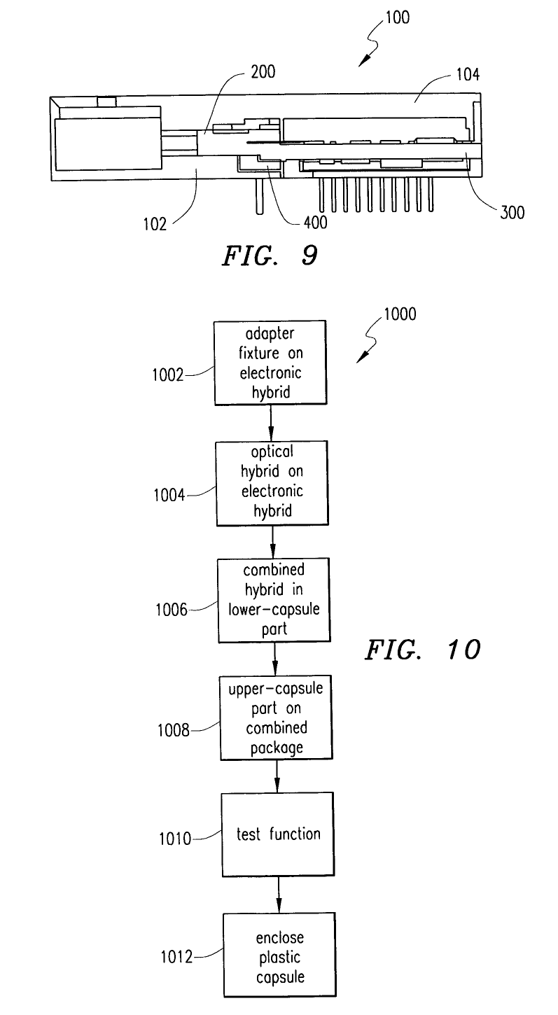

FIG. 9 is a side view of the plastic capsule 100 as assembled in accordance with the invention. The upper-capsule part 104 and the lower-capsule part 102 are shown in a mated configuration on either side of the optical hybrid 200 and the electronic hybrid 300.

The upper-capsule part 104, the lower-capsule part 102, and the electronic hybrid 300 in combination form two separate cavities. The two separate cavities enable mounting of electronic components on both sides of the electronic hybrid 300. Mounting the electronic components on separate sides of the electronic hybrid 300 may be used, for example, to separate transmitter electronics and receiver electronics from one another. By providing a sandwiched common plane to the electronic hybrid 300, the electronic parts can be shielded, thus reducing cross talk.

FIG. 10 is a flow chart that illustrates a plastic-capsule assembly process in accordance with principles of the invention. Manufacture of the plastic capsule is typically planar, or “hamburger” style, in which parts are placed on top of one another. A flow 1000 begins at step 1002. At step 1002, the adapter fixture 400 is placed on top of the electronic hybrid 300. At step 1004, the optical hybrid 200 is placed on top of the electronic hybrid 300. At step 1006, the combined hybrid (i.e., the combination of the electronic hybrid 300, the optical hybrid 200, and the adapter FIG. 400) is placed in the lower-capsule part 102. At step 1008, the upper capsule part 104 is placed on top of the combined package (i.e., the partially assembled plastic capsule after step 1006). At step 1010 an optional test of functionality is performed. At step 1012, the plastic capsule 100 is enclosed. The steps of the flow 1000 need not necessarily be performed in the order shown in FIG. 10. Assembly of the plastic capsule 100 is thus adapted to volume manufacturing. Further, the construction is simple and cost effective.

Although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. An opto-mechanical interface apparatus comprising:
an optical hybrid;
an electronic hybrid adapted to receive electronic components;
an adapter fixture for fixing the electronic hybrid and the optical hybrid to one another to form a combined hybrid;
a lower-capsule part;
an upper-capsule part adapted to mate with the lower-capsule part; and
wherein mating of the upper-capsule part and the lower-capsule part encloses at least part of the combined hybrid.

2. The apparatus of claim 1, wherein the optical hybrid comprises:
an optical chip;
an optical-fiber connector; and
a carrier.

3. The apparatus of claim 2, wherein the optical chip is selected from the group consisting of a transmitter chip and a receiver chip.

4. The apparatus of claim 1, wherein the lower-capsule part comprises airing holes.

5. The apparatus of claim 1, wherein the upper-capsule part comprises airing holes.

6. The apparatus of claim 1, wherein the upper-capsule part and the lower-capsule part are mated together via at least one of snap-locking, gluing, and ultra-sound welding.

7. The apparatus of claim 1, wherein:
the upper-capsule part and the lower-capsule part are mated together; and
the mated-together upper-capsule part and lower-capsule part form at least one cavity.

8. The apparatus of claim 7, wherein the at least one cavity comprises an upper cavity and a lower cavity.

9. The apparatus of claim 8, wherein:
a first portion of the electronic components is contained within the upper cavity; and
a second portion of the electronic components is contained within the lower cavity.

10. The apparatus of claim 9, wherein:
the first portion of the electronic components comprises receiver electronics; and
the second portion of the electronic components comprises transmitter electronics.

11. The apparatus of claim 1, wherein:
the electronic hybrid comprises a printed circuit board (PCB); and
the electronic components are mounted on the PCB.

12. The apparatus of claim 1, wherein the PCB comprises:
a pin for making an external electrical connection; and
a stud for providing stability during assembly.

13. The apparatus of claim 1, wherein the lower-capsule part comprises a lead-through for receiving a protrusion of the electronic hybrid, the protrusion selected from the group consisting of a pin and a stud.

14. The apparatus of claim 1, wherein the lower-capsule part is adapted to permit accurate positioning of the combined hybrid.

15. The apparatus of claim 1, wherein the upper-capsule part is adapted to fix contents of the apparatus.

16. The apparatus of claim 1, wherein the optical hybrid comprises at least one of:
at least one fiber;
at least one transmitter; and
at least one receiver.

17. A method of assembling an opto-mechanical interface apparatus, the method comprising:
forming a combined hybrid, the step of forming the combined hybrid comprising:
attaching an adapter fixture to an electronic hybrid; and
attaching an optical hybrid to the electronic hybrid;
placing the combined hybrid in a first capsule part;
mating a second capsule part with the first capsule part; and
wherein mating of the first capsule part and the second capsule part encloses at least part of the combined hybrid.

18. The method of claim 17, further comprising testing functionality of at least one component of the apparatus prior to the mating step.

19. The method of claim 17, wherein the steps are performed in the order listed.

20. The method of claim 17, wherein the step of mating is performed via at least one of gluing, snap-locking, and ultra-sound welding.

21. The method of claim 17, wherein the step of placing comprises positioning the combined hybrid in the first capsule part.

22. The method of claim 17, wherein the step of mating comprises fixing contents of the apparatus.

23. The method of claim 17, where in the first capsule part is a lower-capsule part and the second capsule part is an upper-capsule part.
